(19) United States
(12) Patent Application Publication
(10) Pub. No.: US 2025/0303901 A1
(43) Pub. Date: Oct. 2, 2025

(54) POWER CONTROL DEVICE

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 18/982,096

(22) Filed: Dec. 16, 2024

(30) Foreign Application Priority Data
Mar. 27, 2024 (JP) 2024-051294

(51) Int. Cl. B60L 53/51; B60L 55/00; B60L 58/18; H02J 7/34; H02J 7/35

(52) U.S. Cl. CPC B60L 53/51; B60L 55/00; B60L 58/18; H02J 7/342; H02J 7/35

(57) ABSTRACT

A power control device for controlling power transfer between a first device and a second device. The power control device includes: a plurality of relays located in a path connecting the first device and the second device; and a control unit configured to control the relays to render the relays conductive or non-conductive, both a normally-on relay that is rendered conductive when not driven and a normally-off relay that is rendered non-conductive when not driven are used as the relays.

### CROSS-REFERENCE TO RELATED APPLICATION

This application claims priority to Japanese Patent Application No. 2024-051294 filed on Mar. 27, 2024, incorporated herein by reference in its entirety.

### BACKGROUND

### 1. Technical Field

The present disclosure relates to power control devices that control power of a battery.

### 2. Description of Related Art

Japanese Unexamined Patent Application Publication No. 2021-083248 (JP 2021-083248 A) discloses a solar charging system. When a solar panel is able to generate power, the solar charging system supplies power from the solar panel to an auxiliary system including an auxiliary battery, and derives power actually generated by the solar panel. When the derived actual generated power is equal to or greater than a specified value, the solar charging system further charges a high-voltage battery with the power generated by the solar panel.

### SUMMARY

In order to control operations such as an operation of charging an auxiliary battery with power generated by a solar panel and an operation of charging the auxiliary battery with power of a high-voltage battery, a plurality of relays is typically provided on power lines through which charging power flows. So-called normally-off relays are usually used as such relays. Normally-off relays are relays that are rendered electrically conductive by driving (turning on) them. However, when the normally-off relays need to be kept conductive for a long period of time in a charging operation etc., it is necessary to keep supplying a drive current to them, which results in increased power consumption.

The present disclosure was made in view of the above issue, and an object of the present disclosure is to provide a power control device that can reduce power consumption when relays need to be kept conductive for a long period of time in a charging operation etc.

In order to solve the above issue, an aspect of the technique of the present disclosure is a power control device that controls power transfer between a first device and a second device.

The power control device includes:
a plurality of relays located in a path connecting the first device and the second device; and a control unit configured to control the relays to render the relays conductive or non-conductive.

Both a normally-on relay that is rendered conductive when not driven and a normally-off relay that is rendered non-conductive when not driven are used as the relays.

The power control device of the present disclosure uses both the normally-on relay and the normally-off relay. Therefore, a drive current needs to be supplied only to the normally-off relay when electrically connecting the first device and the second device. This configuration can reduce power consumption when the relays need to be kept conductive for a long period of time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a power control device according to a first embodiment of the present disclosure;

FIG. 2 is a diagram for explaining a relationship between an operation state of charging and a drive state of a relay;

FIG. 3 is a schematic configuration diagram of a power control device according to a second embodiment of the present disclosure;

FIG. 4 is a schematic configuration diagram of a power control device according to a third embodiment of the present disclosure; and

FIG. 5 is a schematic configuration diagram of a power control device according to a fourth embodiment of the present disclosure.

### DETAILED DESCRIPTION OF EMBODIMENTS

A power control device according to the present disclosure includes both a normally-on relay and a normally-off relay on a line connecting two devices, and drives only the normally-off relay when electrically connecting the two devices. As a result, power consumption in the conductive state can be reduced compared to the case of only the normally-off relays.

Hereinafter, an embodiment of the present disclosure will be described in detail with reference to the drawings.

### First Embodiment

### Configuration

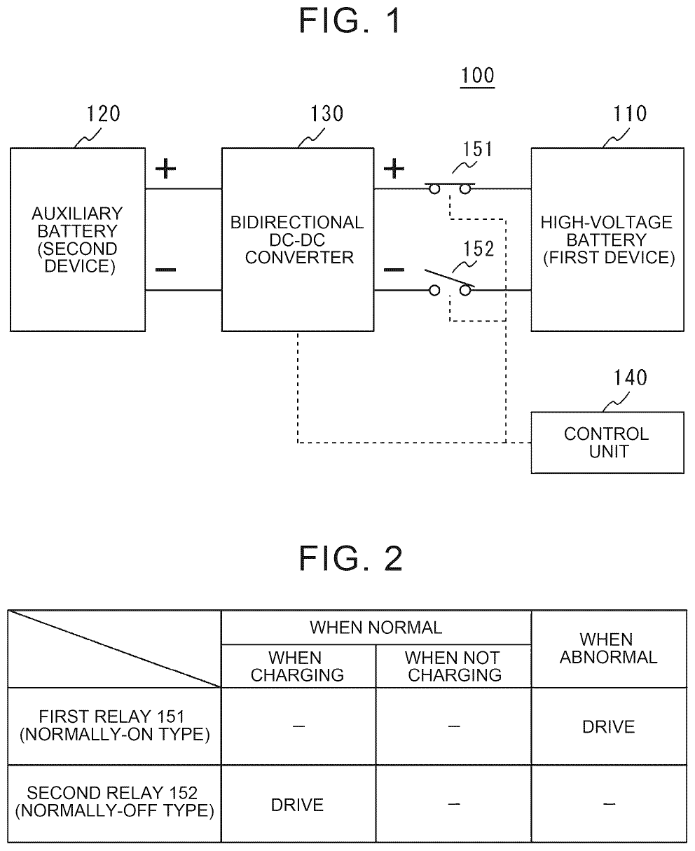

FIG. 1 is a schematic diagram illustrating a configuration of a power control device 100 according to a first embodiment of the present disclosure. The power control device 100 illustrated in FIG. 1 includes a high-voltage battery 110, an auxiliary battery 120, a bidirectional DCDC converter 130, a control unit 140, a first relay 151, and a second relay 152.

The power control device 100 is mounted in a vehicle such as hybrid electric vehicle (HEV), plug-in hybrid electric vehicle (PHEV), and battery electric vehicle (BEV), and is configured to be capable of controlling power transfer (power pumping) from the high-voltage battery 110 (first device) to the auxiliary battery 120 (second device).

The high-voltage battery 110 is a secondary battery configured to be chargeable and dischargeable, such as a lithium-ion battery. The high-voltage battery 110 can supply power necessary for the operation to a main motor load (not shown) such as a traveling electric motor mounted in the vehicle. The high-voltage battery 110 is connected to the auxiliary battery 120 via a bidirectional DCDC converter 130 so that the power stored therein can be supplied to the auxiliary battery 120 and can be charged with the power stored in the auxiliary battery 120. The high-voltage battery 110 is, for example, a driving battery having a rated voltage higher than that of the auxiliary battery 120.

The auxiliary battery 120 is a secondary battery configured to be chargeable and dischargeable, such as a lithium-ion battery or a lead-acid battery. The auxiliary battery 120 can supply power necessary for the operation to an auxiliary load (not shown) such as a lighting device or an air-conditioning device mounted in the vehicle. The auxiliary battery 120 is connected to the high-voltage battery 110 via a bidirectional DCDC converter 130 so as to be able to be charged with the power stored in the high-voltage battery 110 and to be able to supply the power stored in itself to the high-voltage battery 110.

The bidirectional DCDC converter 130 is a bidirectional power converter capable of converting input power into predetermined-voltage power and outputting the converted power. One end (primary side) of the bidirectional DCDC converter 130 is connected to the auxiliary battery 120, and the other end (secondary side) thereof is connected to the high-voltage battery 110. The bidirectional DCDC converter 130 may supply (pump-charge) power outputted from the auxiliary battery 120 connected to one end to the high-voltage battery 110 connected to the other end. At the time of supplying the power, the bidirectional DC-DC converter 130 performs a boosting operation of boosting the voltage of the auxiliary battery 120 inputted to one end to become the outputted voltage of the other end. In addition, the bidirectional DC-DC converter 130 is capable of supplying (pumping out) the power of the high-voltage battery 110 connected to the other end to the auxiliary battery 120 connected to the one end. When the power is supplied, the bidirectional DCDC converter 130 performs a step-down operation in which the voltage of the high-voltage battery 110 inputted to the other end is stepped down to be the outputted voltage of the one end. The operation of the bidirectional DCDC converter 130 is controlled by the control unit 140.

The first relay 151 and the second relay 152 are configured to control power outputting from the high-voltage battery 110, and are provided between the high-voltage battery 110 and the bidirectional DCDC converter 130. The first relay 151 is inserted on the positive power line, and the second relay 152 is inserted on the negative (GND) power line. The first relay 151 is a normally-on relay that is rendered conductive when it is not driven (turned off), namely when it does not consume power, and is rendered non-conductive when it is driven (turned on), namely when it consumes power. The second relay 152 is a normally-off relay that is rendered non-conductive when it is not driven (turned off), namely when it does not consume power, and is rendered conductive when it is driven (turned on), namely when it consumes power. For the first relay 151 and the second relay 152, for example, an exciting mechanical relay is used.

Note that the position on the power line in which the first relay 151 and the second relay 152 are inserted may be reversed, or the first relay 151 and the second relay 152 may be inserted in series on one of the power lines. The first relay 151 and the second relay 152 are not limited to those that do not consume power when they are not driven (turned off), and may be those that consume less power when they are not driven (turned off) than when they are driven (turned on).

The control unit 140 includes, for example, a microcomputer, and is configured to control the operation of the bidirectional DCDC converter 130, the conductive/non-conductive state of the first relay 151 and the second relay 152, etc. The control unit 140 can control necessary power transfer according to the state of the high-voltage battery 110 and the auxiliary battery 120 and the request of the vehicle.

### Relay Operation

FIG. 2 is a diagram illustrating an example of control of the first relay 151 and the second relay 152 that is performed by the control unit 140.

When the high-voltage battery 110 and the auxiliary battery 120 are normal and the power of the high-voltage battery 110 is not charged (pumped-out charge) to the auxiliary battery 120, the control unit 140 drives neither the first relay 151 nor the second relay 152. As a result, the high-voltage battery 110 and the bidirectional DCDC converter 130 can be electrically disconnected from each other without consuming power (while suppressing low power consumption).

When the high-voltage battery 110 and the auxiliary battery 120 are normal and the power of the high-voltage battery 110 is charged to the auxiliary battery 120, the control unit 140 drives the second relay 152. As a result, the high-voltage battery 110 and the bidirectional DCDC converter 130 can be electrically connected only by consuming the power of the second relay 152. An example of the connection method is to drive the second relay 152 intermittently for 24 hours or to drive the second relay 152 constantly for 24 hours.

On the other hand, when at least one of the high-voltage battery 110 and the 30 auxiliary battery 120 is abnormal, the control unit 140 drives the first relay 151. As a result, both of the first relay 151 and the second relay 152 are rendered non-conductive, so that the high-voltage battery 110 can be more safely disconnected from the bidirectional DC-DC converter 130.

### Second Embodiment

### Configuration

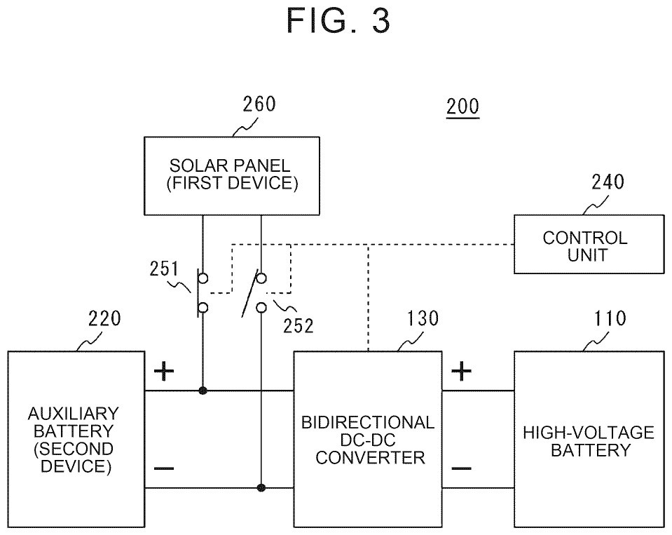

FIG. 3 is a schematic diagram illustrating a configuration of a power control device 200 according to a second embodiment of the present disclosure. The power control device 200 illustrated in FIG. 3 includes a high-voltage battery 110, an auxiliary battery 220, a bidirectional DCDC converter 130, a control unit 240, a first relay 251, a second relay 252, and a solar panel 260.

The power control device 200 is mounted in a vehicle such as hybrid electric vehicle (HEV), plug-in hybrid electric vehicle (PHEV), and battery electric vehicle (BEV), and is configured to be capable of controlling charging (solar charging) of the auxiliary battery 120 (second device) by the solar panel 260 (first device).

In the power control device 200, the same components as those of the power control device 100 are denoted by the same reference numerals, and description thereof is omitted.

The solar panel 260 is a power generation device that generates power by being irradiated with sunlight, and outputs the generated power (generated power) to the auxiliary battery 120 or the like. The solar panel 260 includes a panel that is an assembly of solar cells, and a MPPT control unit (MPPT) that realizes a maximum power point of power generation in the panel by follow-up control.

The auxiliary battery 220 is a secondary battery configured to be chargeable and dischargeable, such as a lithium-ion battery or a lead-acid battery. The auxiliary battery 220 can supply power necessary for the operation to an auxiliary load (not shown) such as a lighting device or an air-conditioning device mounted in the vehicle. The auxiliary battery 220 is connected to the solar panel 260 so as to be able to be charged with power generated by the solar panel 260. The auxiliary battery 220 is connected to the high-voltage battery 110 via a bidirectional DCDC converter 130 so as to be able to be charged with the power stored in the high-voltage battery 110 and to be able to supply the power stored in itself to the high-voltage battery 110.

The first relay 251 and the second relay 252 are configurations for controlling the power output from the solar panel 260, and are provided between the solar panel 260 and the auxiliary battery 220. The first relay 251 is inserted on the positive power line, and the second relay 252 is inserted on the negative (GND) power line. The first relay 251 is a normally-on relay that is rendered conductive when it is not driven (turned off), namely when it does not consume power, and is rendered non-conductive when it is driven (turned on), namely when it consumes power. The second relay 252 is a normally-off relay that is rendered non-conductive when it is not driven (turned off), namely when it does not consume power, and is rendered conductive when it is driven (turned on), namely when it consumes power. For the first relay 251 and the second relay 252, for example, an exciting mechanical relay is used.

Note that the position on the power line in which the first relay 251 and the second relay 252 are inserted may be reversed, or the first relay 251 and the second relay 252 may be inserted in series on one of the power lines. The first relay 251 and the second relay 252 are not limited to those that do not consume power when they are not driven (turned off), and may be those that consume less power when they are not driven (turned off) than when they are driven (turned on).

The control unit 240 includes, for example, a microcomputer, and is configured to control the operation of the bidirectional DCDC converter 130, the conductive/non-conductive state of the first relay 251 and the second relay 252, etc. The control unit 240 can control necessary power transfer according to the state of the solar panel 260 and the auxiliary battery 220 and the request of the vehicle.

### Relay Operation

When the solar panel 260 and the auxiliary battery 220 are normal and the solar panel 260 is not generating power (does not output power to be charged), the control unit 240 drives neither the first relay 251 nor the second relay 252. As a result, the solar panel 260 and the auxiliary battery 220 can be electrically disconnected from each other without consuming power (while suppressing low power consumption).

When the solar panel 260 and the auxiliary battery 220 are normal and the solar panel 260 is generating power (outputting power to be charged), the control unit 240 drives the second relay 252. Thus, the solar panel 260 and the auxiliary battery 220 can be electrically connected only by the power consumption of the second relay 252. As an example of the connection method, the second relay 252 is driven during a period in which solar radiation is present on the solar panel 260.

On the other hand, when at least one of the solar panel 260 and the auxiliary battery 220 is abnormal, the control unit 240 drives the first relay 251. As a result, both the first relay 251 and the second relay 252 are rendered non-conductive, so that the solar panel 260 can be more safely disconnected from the auxiliary battery 220.

### Third Embodiment

### Configuration

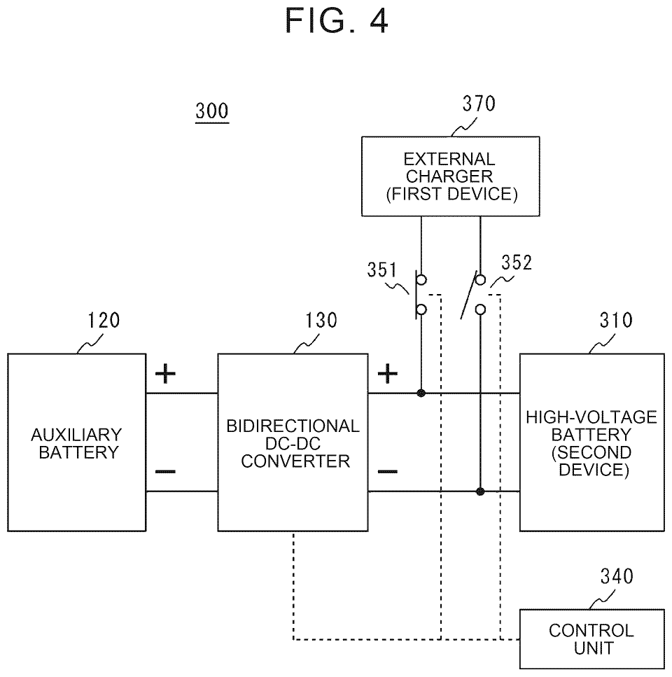

FIG. 4 is a schematic diagram illustrating a configuration of a power control device 300 according to a third embodiment of the present disclosure. The power control device 300 illustrated in FIG. 4 includes a high-voltage battery 310, an auxiliary battery 120, a bidirectional DCDC converter 130, a control unit 340, a first relay 351, a second relay 352, and an external charger 370.

The power control device 300 is mounted in a vehicle such as hybrid electric vehicle (HEV), plug-in hybrid electric vehicle (PHEV), and battery electric vehicle (BEV), and is configured to be capable of controlling charging (external charging) of the high-voltage battery 310 (second device) by the external charger 370 (first device).

In the power control device 300, the same components as those of the power control device 100 are denoted by the same reference numerals, and description thereof is omitted.

The external charger 370 is a charger, a charging facility, or the like connected to the vehicle, and is configured to charge the high-voltage battery 310. The external charger 370 can be attached to and detached from a charging outlet (not shown) provided in the vehicle.

The high-voltage battery 310 is a secondary battery configured to be chargeable and dischargeable, such as a lithium-ion battery. The high-voltage battery 310 can supply power necessary for the operation to a main motor load (not shown) such as a traveling electric motor mounted in the vehicle. The high-voltage battery 310 is connected to the auxiliary battery 120 via a bidirectional DCDC converter 130 so that the power stored therein can be supplied to the auxiliary battery 120 and can be charged by the power stored in the auxiliary battery 120. The high-voltage battery 310 is connected to the external charger 370 so as to be able to be charged with power supplied from the external charger 370.

The first relay 351 and the second relay 352 are configured to control power supply from the external charger 370, and are provided between the external charger 370 and the high-voltage battery 310. The first relay 351 is inserted on the positive power line, and the second relay 352 is inserted on the negative (GND) power line. The first relay 351 is a normally-on relay that is rendered conductive when it is not driven (turned off), namely when it does not consume power, and is rendered non-conductive when it is driven (turned on), namely when it consumes power. The second relay 352 is a normally-off relay that is rendered non-conductive when it is not driven (turned off), namely when it does not consume power, and is rendered conductive when it is driven (turned on), namely when it consumes power. For the first relay 351 and the second relay 352, for example, an exciting mechanical relay is used.

Note that the position on the power line in which the first relay 351 and the second relay 352 are inserted may be reversed, or the first relay 351 and the second relay 352 may be inserted in series on one of the power lines. The first relay 351 and the second relay 352 are not limited to those that do not consume power when they are not driven (turned off), and may be those that consume less power when they are not driven (turned off) than when they are driven (turned on).

The control unit 340 includes, for example, a microcomputer, and is configured to control the operation of the bidirectional DCDC converter 130, the conductive/non-conductive state of the first relay 351 and the second relay 352, etc. The control unit 340 can control necessary power transfer according to the state of the external charger 370 and the high-voltage battery 310 and the request of the vehicle.

### Relay Operation

When the external charger 370 and the high-voltage battery 310 are normal and the external charger 370 is not connected to the vehicle (connected but not supplied with power), the control unit 340 does not drive both the first relay 351 and the second relay 352.

As a result, the external charger 370 can be disconnected from the vehicle without consuming power (while keeping the power consumption low).

When the external charger 370 and the high-voltage battery 310 are normal and the external charger 370 is connected to the vehicle and power is supplied, the control unit 340 drives the second relay 352. Thus, the external charger 370 can be electrically connected to the vehicle only by the power consumption of the second relay 352. As an example of the connection method, the second relay 352 is driven when charging is performed for a long time from a low-output charging facility (such as a household outlet).

On the other hand, when at least one of the external charger 370 and the high-voltage battery 310 is abnormal, the control unit 340 drives the first relay 351. As a result, both the first relay 351 and the second relay 352 are rendered non-conductive, so that the external charger 370 can be more safely disconnected from the vehicle.

### Fourth Embodiment

### Configuration

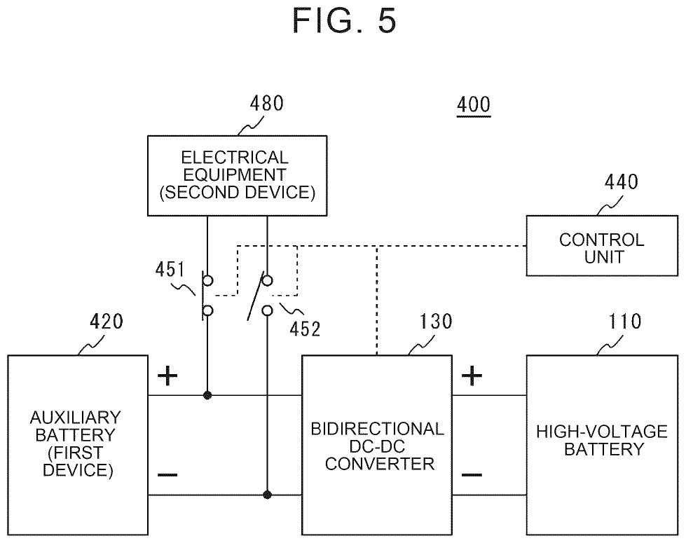

FIG. 5 is a schematic diagram illustrating a configuration of a power control device 400 according to a fourth embodiment of the present disclosure. The power control device 400 illustrated in FIG. 5 includes a high-voltage battery 110, an auxiliary battery 420, a bidirectional DCDC converter 130, a control unit 440, a first relay 451, a second relay 452, and electrical equipment 480.

The power control device 400 is mounted in a vehicle such as hybrid electric vehicle (HEV), plug-in hybrid electric vehicle (PHEV), and battery electric vehicle (BEV), and is configured to be capable of controlling power supplied (external power supply) to the electrical equipment 480 (second device) by the auxiliary battery 420 (first device).

In the power control device 400, the same components as those of the power control device 100 are denoted by the same reference numerals, and description thereof is omitted.

The electrical equipment 480 is an electric appliance that consumes power such as an acoustic product or a lighting device. The electrical equipment 480 can be attached to and detached from a power supply outlet (not shown) provided in the vehicle.

The auxiliary battery 420 is a secondary battery configured to be chargeable and dischargeable, such as a lithium-ion battery or a lead-acid battery. The auxiliary battery 420 can supply power necessary for the operation to an auxiliary load (not shown) such as a lighting device or an air-conditioning device mounted in the vehicle. The auxiliary battery 420 is connected to the electrical equipment 480 so that the power stored in itself can be supplied to the electrical equipment 480. The auxiliary battery 420 is connected to the high-voltage battery 110 via a bidirectional DCDC converter 130 so as to be able to be charged by the power stored in the high-voltage battery 110 and to be able to supply the power stored in itself to the high-voltage battery 110.

The first relay 451 and the second relay 452 are configured to control power supply from the auxiliary battery 420, and are provided between the auxiliary battery 420 and the electrical equipment 480. The first relay 451 is inserted on the positive power line, and the second relay 452 is inserted on the negative (GND) power line. The first relay 451 is a normally-on relay that is rendered conductive when it is not driven (turned off), namely when it does not consume power, and is rendered non-conductive when it is driven (turned on), namely when it consumes power. The second relay 452 is a normally-off relay that is rendered non-conductive when it is not driven (turned off), namely when it does not consume power, and is rendered conductive when it is driven (turned on), namely when it consumes power. For the first relay 451 and the second relay 452, for example, an exciting mechanical relay is used.

Note that the position on the power line in which the first relay 451 and the second relay 452 are inserted may be reversed, or the first relay 451 and the second relay 452 may be inserted in series on one of the power lines. The first relay 451 and the second relay 452 are not limited to those that do not consume power when they are not driven (turned off), and may be those that consume less power when they are not driven (turned off) than when they are driven (turned on).

The control unit 440 includes, for example, a microcomputer, and is configured to control the operation of the bidirectional DCDC converter 130, the conductive/non-conductive state of the first relay 451 and the second relay 452, etc. The control unit 440 can control necessary power transfer according to the state of the auxiliary battery 420 and the electrical equipment 480 and the request of the vehicle.

### Relay Operation

When the auxiliary battery 420 and the electrical equipment 480 are normal and the electrical equipment 480 is not connected to the vehicle (connected but there is no power demand), the control unit 440 drives neither the first relay 451 nor the second relay 452. Thus, it is possible to stop the output from the power supply outlet.

When the auxiliary battery 420 and the electrical equipment 480 are normal and the electrical equipment 480 is connected to the vehicle and there is power demand, the control unit 440 drives the second relay 452. Thus, the electrical equipment 480 can be electrically connected to the vehicle and supplied with power only by the power consumption of the second relay 452. As an example of the connection method, the second relay 452 is driven in a case where a low-power supply (such as lighting of a lantern for camping) is performed for a long time.

On the other hand, when at least one of the auxiliary battery 420 and the electrical equipment 480 is abnormal, the control unit 440 drives the first relay 451. As a result, both of the first relay 451 and the second relay 452 are rendered non-conductive, and the electrical equipment 480 can be more safely disconnected from the vehicle and protected.

### Operations and Effects

As described above, according to the power control device of the embodiment of the present disclosure, when the first device and the second device are connected via a plurality of relays, both the normally-on relay and the normally-off relay are included in the plurality of relays.

With this configuration, when the first device and the second device are connected to each other, only the normally-off relay needs to be driven. Therefore, when the relays need to be kept conductive for a long period of time (ON period of the relays is long), power consumption can be reduced while ensuring the safety performance compared to a circuit composed only of normally-off relays.

The power control device of the present disclosure can be used for a vehicle or the like that controls the power of a battery.

What is claimed is:

1. A power control device that controls power transfer between a first device and a second device, the power control device comprising:
a plurality of relays located in a path connecting the first device and the second device; and
a control unit configured to control the relays to render the relays conductive or non-conductive, wherein both a normally-on relay that is rendered conductive when not driven and a normally-off relay that is rendered non-conductive when not driven are used as the relays.

2. The power control device according to claim 1, wherein
the power control device is mounted in a vehicle,
the first device is a high-voltage battery,
the second device is an auxiliary battery, and
the relays are located on a power line configured to charge the auxiliary battery with power of the high-voltage battery.

3. The power control device according to claim 1, wherein
the power control device is mounted in a vehicle,
the first device is a solar panel,
the second device is an auxiliary battery, and
the relays are located on a power line configured to charge the auxiliary battery with power generated by the solar panel.

4. The power control device according to claim 1, wherein
the power control device is mounted in a vehicle,
the first device is an external charger,
the second device is a high-voltage battery, and
the relays are located on a power line configured to charge the high-voltage battery with power of the external charger.

5. The power control device according to claim 1, wherein
the power control device is mounted in a vehicle,
the first device is an auxiliary battery,
the second device is electrical equipment, and
the relays are located on a power line configured to supply power of the auxiliary battery to the electrical equipment.

6. The power control device according to claim 1, wherein the control unit is configured to drive the normally-off relay during a period of charging or power supply from the first device to the second device.
